(19) United States
(12) Patent Application Publication
(10) Pub. No.: US 2016/0142900 A1
(43) Pub. Date: May 19, 2016

(54) WIRELESS SERIAL BUS SERVICE CONTINUITY

(71) Applicant: QUALCOMM Incorporated, San Diego, CA (US)

(72) Inventors: Shivraj Singh Sandhu, Milpitas, CA (US); Xiaolong Huang, Morgan Hill, CA (US); Andrew Davidson, Monte Sereno, CA (US)

(21) Appl. No.: 14/933,566

(22) Filed: Nov. 5, 2015

Related U.S. Application Data
(60) Provisional application No. 62/080,926, filed on Nov. 17, 2014.

(51) Int. Cl. H04W 8/00

(52) U.S. Cl. CPC H04W 8/005; H04W 8/22

(57) ABSTRACT

Methods, systems, apparatuses, and devices are described for continuity of a wireless serial bus (WSB) service across multiple WSB service sessions. A host may perform a discovery process with a device as part of WSB service session establishment. The host may determine an identifier that is unique to the WSB service provided during the first WSB service session and send the unique identifier to the device. If the WSB service session is terminated, the host may establish a second WSB service session with the device using the unique identifier and without performing another discovery process with the device. The WSB service may support universal serial bus (USB) over Wi-Fi services.

### CROSS REFERENCES

The present Application for Patent claims priority to U.S. Provisional Patent Application No. 62/080,926 by Sandhu et al., titled “Wireless Serial Bus Service Continuity,” filed Nov. 17, 2014, assigned to the assignee hereof, and expressly incorporated by reference herein.

### BACKGROUND

1. Field of the Disclosure

The present disclosure, for example, relates to wireless communication systems, and more particularly to continuity in a wireless serial bus service.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with at least one station(s) (STAs) or mobile devices. The AP may be coupled to a network, such as the Internet, and enable a mobile device to communicate via the network (and/or communicate with other devices coupled to the access point).

A wireless station may support wireless serial bus (WSB) services using an application service platform (ASP) interface or function. The WSB service may provide for serial bus functionality via a wireless link and may be associated with such features as universal serial bus (USB) over Wi-Fi, for example. Generally, the ASP protocol operating on the host wireless station establishes and provides the wireless link between the wireless station (host) and the device, e.g., printer device, monitor, storage device, input device, etc. Once the ASP link is established, the WSB protocol operating on the host wireless station initiates the WSB service and may begin a learning process where it determines the particulars of the device, e.g., manufacturer, product identification, configuration information, driver information, etc. This learning or enumeration process enables the host wireless station to utilize the functions of the device via the wireless link provided by the ASP.

A wireless link, however, may be interrupted and thereby interfere with the WSB service session. For example, a user may end the ASP function intentionally or accidentally (e.g., by walking away with the wireless station). The interruption may be momentary or longer in duration. Current WSB service implementations do not provide a mechanism to support such interruptions and, instead, require a new discovery or learning process at the beginning of each WSB service session. This can be inefficient and requires additional time (while waiting on the host to recognize and register the device) and resources of the host wireless station and the device.

### SUMMARY

The described features generally relate to various improved systems, methods, and/or apparatuses for wireless communication. Such systems, methods, and/or apparatuses may provide for continuity of the WSB service across multiple WSB service sessions. The techniques may include the host wireless station (or a WSB service protocol operating on the host) completing the learning or enumeration process with the device. The learning process may establish (or be a component of the establishment of) the WSB service session between the host wireless station and the device. The host wireless station may select, identify, or otherwise determine an identifier that is unique for the WSB service and store this information during the WSB service session. The host wireless station may send, transmit, or otherwise communicate the unique identifier (or information indicative of the unique identifier) to the device for storage. When the WSB service session is interrupted for any reason, the host wireless station and the device may store the unique identifier for a period of time and use it when they are reconnected to avoid the enumeration process. For example, when the ASP session is activated again, the host wireless station may receive the device identification information via the ASP protocol and associate it with the unique identifier for the WSB service. The host wireless station may send the unique identifier to the device and receive an acknowledgement that the device has the unique identifier and therefore refrain from performing the learning process for the subsequent WSB service session.

In a first set of illustrative examples, a method for wireless communication is provided. The method may include: performing a first discovery process with a device to establish a first wireless serial bus (WSB) service session; determining a unique identifier associated with a WSB service provided at least in part via the first WSB service session; and communicating information indicative of the unique identifier to the device.

In some aspects, the method may include: determining that the first WSB service session has terminated; determining that the device is available for a second WSB service session; and establishing the second WSB service session based at least in part on the unique identifier. The method may include refraining from performing a second discovery process to establish the second WSB service session. The method may include communicating information indicative of the unique identifier to the device to establish the second WSB service session. Determining that the device is available for a second WSB service session may include: receiving information indicative of a device identification (ID) for the device; and associating the device ID with the unique identifier for the first WSB service session. Establishing the second WSB service session may include communicating information associated with a remote wakeup procedure.

In some aspects, the method may include storing the unique identifier. The method may include storing a plurality of unique identifiers for a corresponding plurality of devices, each of the plurality of devices having previously established a WSB service session. The method of may include communicating an indicator to the device associated with the device storing the unique identifier. The method may include: receiving a signal indicating that the first WSB service session is being terminated; and storing the unique identifier based at least in part on the receiving.

In some aspects, the method may include: determining that the first WSB service session has terminated based on a period of inactivity having a predetermined length; and storing the unique identifier based at least in part on the determining. The first WSB service session may be established via an application service platform (ASP) session. The WSB service may be associated with a universal serial bus (USB) over Wi-Fi service. The first discovery process may include a USB enumeration process.

In a second set of illustrative examples, an apparatus for wireless communication is provided. The apparatus may include: a processor; memory in electronic communication with the processor; and instructions being stored in the memory. The instructions may be executable by the processor to: perform a first discovery process with a device to establish a first wireless serial bus (WSB) service session; determine a unique identifier associated with a WSB service provided at least in part via the first WSB service session; and communicate information indicative of the unique identifier to the device.

In some aspects, the apparatus may include instructions executable by the processor to: determine that the first WSB service session has terminated; determine that the device is available for a second WSB service session; and establish the second WSB service session based at least in part on the unique identifier. The apparatus may include instructions executable by the processor to refrain from performing a second discovery process to establish the second WSB service session. The apparatus may include instructions executable by the processor to communicate information indicative of the unique identifier to the device to establish the second WSB service session. The instructions to determine that the device is available for a second WSB service session may also be executable by the processor to: receive information indicative of a device identification (ID) for the device; and associate the device ID with the unique identifier for the first WSB service session.

In some aspects, the instructions to establish the second WSB service session may also be executable by the processor to communicate information associated with a remote wakeup procedure. The apparatus may include instructions executable by the processor to store the unique identifier. The apparatus may include instructions executable by the processor to store a plurality of unique identifiers for a corresponding plurality of devices, each of the plurality of devices having previously established a WSB service session.

In some aspects, the apparatus may include instructions executable by the processor to communicate an indicator to the device associated with the device storing the unique identifier. The apparatus may include instructions executable by the processor to: receive a signal indicating that the first WSB service session is being terminated; and store the unique identifier based at least in part on the receiving.

In some aspects, the apparatus may include instructions executable by the processor to: determine that the first WSB service session has terminated based on a period of inactivity having a predetermined length; and store the unique identifier based at least in part on the determining. The first WSB service session may be established via an application service platform (ASP) session. The WSB service may be associated with a universal serial bus (USB) over Wi-Fi service. The first discovery process may include a USB enumeration process.

In a third set of illustrative examples, an apparatus for wireless communication is provided. The apparatus may include: means for performing a first discovery process with a device to establish a first wireless serial bus (WSB) service session; means for determining a unique identifier associated with a WSB service provided at least in part via the first WSB service session; and means for communicating information indicative of the unique identifier to the device.

In some aspects, the apparatus may include: means for determining that the first WSB service session has terminated; means for determining that the device is available for a second WSB service session; and means for establishing the second WSB service session based at least in part on the unique identifier. The apparatus may include means for refraining from performing a second discovery process to establish the second WSB service session.

In a further set of illustrative examples, a non-transitory computer-readable medium storing computer-executable code for wireless communication is provided. The code may be executable by a processor to: perform a first discovery process with a device to establish a first wireless serial bus (WSB) service session; determine a unique identifier associated with a WSB service provided at least in part via the first WSB service session; and communicate information indicative of the unique identifier to the device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description can be applicable to any one of the similar components having the same first reference label irrespective of the second reference label.

FIG. 1 shows a block diagram of a wireless communication system, in accordance with various aspects of the present disclosure;

FIG. 2 shows a block diagram of an apparatus for use in wireless communication, in accordance with various aspects of the present disclosure;

FIG. 3 shows a block diagram of an apparatus for use in wireless communication, in accordance with various aspects of the present disclosure;

FIG. 4 shows a block diagram of an apparatus for use in wireless communication, in accordance with various aspects of the present disclosure;

FIG. 5 shows a block diagram of a wireless station for use in wireless communication, in accordance with various aspects of the present disclosure;

FIG. 6 shows a swim lane diagram illustrating aspects of wireless communication, in accordance with various aspects of the present disclosure;

FIG. 7 shows a swim lane diagram illustrating aspects of wireless communication, in accordance with various aspects of the present disclosure;

FIG. 8 shows a swim lane diagram illustrating aspects of wireless communication, in accordance with various aspects of the present disclosure;

FIG. 9 shows a flow chart illustrating an example of a method for wireless communication, in accordance with various aspects of the present disclosure;

FIG. 10 shows a flow chart illustrating an example of a method for wireless communication, in accordance with various aspects of the present disclosure; and

FIG. 11 shows a flow chart illustrating an example of a method for wireless communication, in accordance with various aspects of the present disclosure.

### DETAILED DESCRIPTION

Protocols supporting serial bus functionality are generally geared toward a wired connection. A WSB service permits the serial bus service to be performed over a wireless connection and generally includes an underlying ASP protocol that transparently provides the wireless link over which the WSB service operates. When a host wireless station (“host”) establishes a WSB service session with a device to perform WSB services, the host ‘discovers’ the device by learning or enumerating the specific details of the device. The discovery process permits the host and the device to exchange information to enable interoperability. Operating a WSB service via a wireless link can be problematic when, for example, the underlying wireless ASP session may be prone to interruption. Current serial bus protocols are not adapted to support such interruptions and generally require the host and the device to learn each other again when they reconnect. This can be especially problematic when the wireless link (and by extension the ASP session) experiences frequent, brief interruptions, for example.

Aspects of the present disclosure relate to continuity of the WSB service when a WSB service session is interrupted. In some aspects, the host may identify or select an identifier that can be unique for a WSB service between the host and the device. For example, the host may associate the unique identifier with the device identification information. The host may communicate the unique identifier to the device. When there is an interruption in the WSB service session (e.g., the ASP session is terminated), the host and the device may store the unique identifier for the WSB service. When the underlying ASP session is restored (e.g., the host and device come into communication range again), the host may re-establish the WSB service in a new WSB service session using the unique identifier. For example, the host and device may exchange information associated with the unique identifier to discover each other without having to complete the learning process again. Accordingly, the host may persist the WSB service across multiple WSB service sessions and quickly reconnect to the device. This may improve user experience by reducing the time the user waits for the host to enumerate the details of the device. In some examples, the WSB service may support USB over Wi-Fi functionality.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

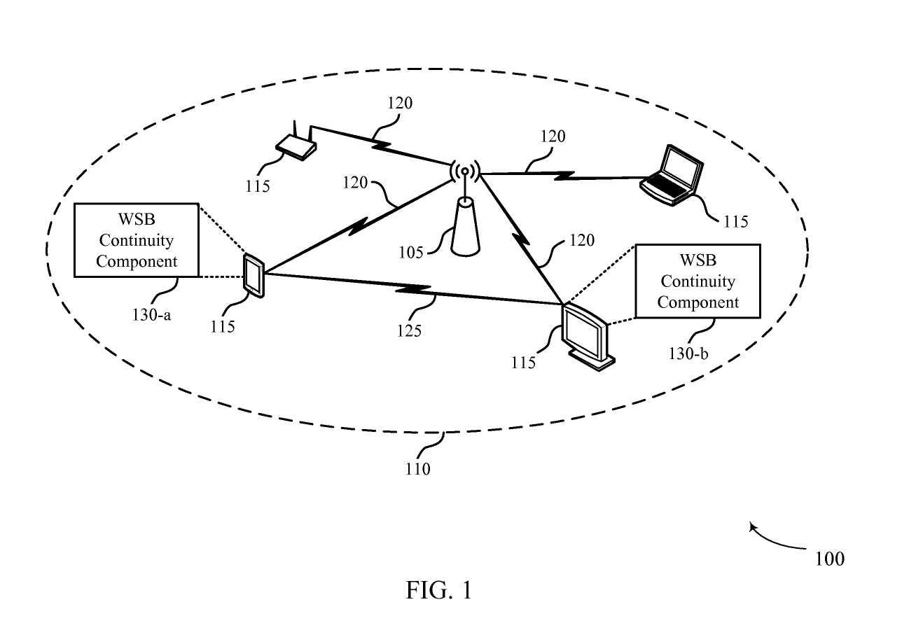

Referring first to FIG. 1, a block diagram illustrates an example of a WLAN network 100 implementing at least one of the IEEE 802.11 family of standards. The WLAN network 100 may include an access point (AP) 105 and wireless devices or stations (STAs) 115, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the WLAN network 100 may have multiple APs 105. Each of the wireless stations 115, which may also be referred to as mobile stations (MSs), mobile devices, access terminals (ATs), user equipment (UE), subscriber stations (SSs), or subscriber units, may associate and communicate with an AP 105 via a communication link 120. Each AP 105 has a geographic coverage area 110 such that wireless stations 115 within that area can typically communicate with the AP 105. The wireless stations 115 may be dispersed throughout the geographic coverage area 110. Each wireless station 115 may be stationary or mobile.

Although not shown in FIG. 1, a wireless station 115 can be covered by more than one AP 105 and can therefore associate with APs 105 at different times. A single AP 105 and an associated set of stations may be referred to as a basic service set (BSS). An extended service set (ESS) can be a set of connected BSSs. A distribution system (DS) (not shown) can be used to connect APs 105 in an extended service set. A geographic coverage area 110 for an access point 105 may be divided into sectors making up only a portion of the coverage area (not shown). The WLAN network 100 may include access points 105 of different types (e.g., metropolitan area, home network, etc.), with varying sizes of coverage areas and overlapping coverage areas for different technologies. Although not shown, other wireless devices can communicate with the AP 105.

While the wireless stations 115 may communicate with each other through the AP 105 using communication links 120, each wireless station 115 may also communicate directly with other wireless stations 115 via a direct wireless link 125. Two or more wireless stations 115 may communicate via a direct wireless link 125 when both wireless stations 115 are in the AP geographic coverage area 110 or when one or neither wireless station 115 is within the AP geographic coverage area 110 (not shown). Examples of direct wireless links 125 may include Wi-Fi Direct connections, connections established by using a Wi-Fi Tunneled Direct Link Setup (TDLS) link, and other P2P group connections. In some examples, the wireless stations 115 may communicate via direct wireless link 125 to provide for USB over Wi-Fi functionality. The wireless stations 115 in these examples may communicate according to the WLAN radio and baseband protocol including physical and MAC layers from IEEE 802.11 standard, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within WLAN network 100.

Wireless stations 115 may include a WSB continuity component 130 that manages aspects of continuity of a WSB service between wireless stations 115 across more than one WSB service session. The wireless stations 115 may support communication techniques that utilize Wi-Fi links to support serial bus operations, e.g., wireless USB functionality. The WSB continuity component 130 for a host wireless station 115 (e.g., WSB continuity component 130-a) may connect to a WSB continuity component 130 for a device (e.g., WSB continuity component 130-b) and perform a discovery operation to form, or as a part of, a WSB service session. The WSB service session may operate via an ASP session between the wireless stations 115. The WSB continuity component 130-a may determine or identify an identifier that can be unique to the WSB service with the WSB continuity component 130-b. The WSB continuity component 130-a may send the unique identifier, or information indicative thereof, to the WSB continuity component 130-b. When the WSB service session terminates, e.g., the underlying ASP session can be disrupted, the WSB continuity components 130 may store the unique identifier and, for a subsequent WSB service session, continue to the WSB service using the unique identifier. For example, the WSB continuity components 130 may use the unique identifiers to continue the WSB service without performing another discovery process.

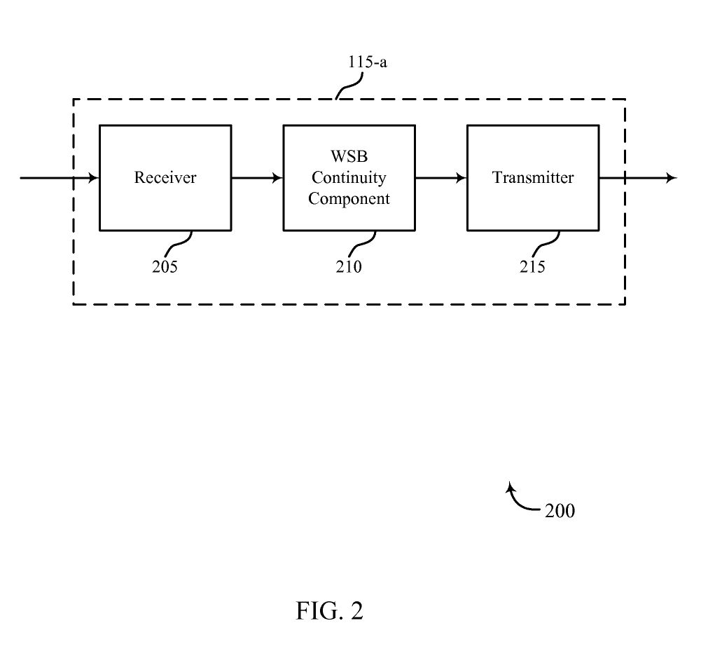

FIG. 2 shows a block diagram 200 of an apparatus 115-a for use in a wireless station for wireless communication, in accordance with various aspects of the present disclosure. In some examples, the apparatus 115-a may be an example of aspects of the wireless stations 115 described with reference to FIG. 1. The apparatus 115-a may also be or include a processor (not shown). The apparatus 115-a may include a receiver 205, a WSB continuity component 210, and/or a transmitter 215. Each of these components may be in communication with each other.

The apparatus 115-a, through the receiver 205, the WSB continuity component 210, and/or the transmitter 215, may perform functions described herein. For example, the apparatus 115-a may manage aspects of continuity of a WSB service across multiple WSB service sessions for the apparatus 115-a.

The components of the apparatus 115-a may, individually or collectively, be implemented using ASICs adapted to perform some or all of the applicable functions in hardware. Alternatively, the functions may be performed by other processing units (or cores), on integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by general or application-specific processors.

The receiver 205 may receive information such as packets, user data, and/or control information associated with various information channels (e.g., control channels, data channels, etc.). The receiver 205 may receive signals, messages, and the like from a device associated with an ASP session, a WSB service session, and the like. The receiver 205 may receive signals, messages, and the like from the device associated with WSB service continuity using an identifier unique to the WSB service. Information may be passed on to the WSB continuity component 210, and to other components of the apparatus 115-a.

The WSB continuity component 210 may manage aspects of WSB service continuity for the apparatus 115-a. The WSB continuity component 210 may, alone or in cooperation with other components of the apparatus 115-a, manage aspects of establishing an ASP session with a device the apparatus 115-a seeks to perform a WSB service with. The WSB continuity component 210 may complete an enumeration process, once the Encapsulating Security Payload (ESP) session is established, to discover the details of a device for a WSB service. The enumeration or learning process may include receiving information associated with the device to enable the WSB service interoperability. Once the WSB service session is active, the WSB continuity component 210 may identify or determine an identifier that can be unique to the WSB service with the device. The unique identifier may be shared with the device and stored by the WSB continuity component 210 and the device when the underlying ASP session terminates, for example.

In some aspects, the WSB continuity component 210 may receive, via the receiver 205, information indicating that the device is available for a second WSB service session. For example, the apparatus 115-a and the device may initiate a second ASP session and exchange device ID information. The WSB continuity component 210 may send the unique identifier to the device to initiate the WSB service session and, based on receiving an acknowledgement of the unique identifier from the device, omit or refrain from performing the enumeration or learning process with the device. That is, the WSB continuity component 210 may associate the unique identifier with the particular of the device and, therefore, already know the necessary information needed to ensure interoperability. Accordingly, the apparatus 115-a, via the WSB continuity component 210, and the device may quickly begin a second or subsequent WSB service session to continue the WSB service. The WSB service may, in some examples, support USB over Wi-Fi functionality.

The transmitter 215 may transmit the signals received from other components of the apparatus 115-a. The transmitter 215 may transmit various signals, messages, etc., associated with an underlying ASP session and continuity of a WSB service across more than one WSB service session. In some examples, the transmitter 215 may be collocated with the receiver 205 in a transceiver component. The transmitter 215 may include a single antenna, or it may include a plurality of antennas.

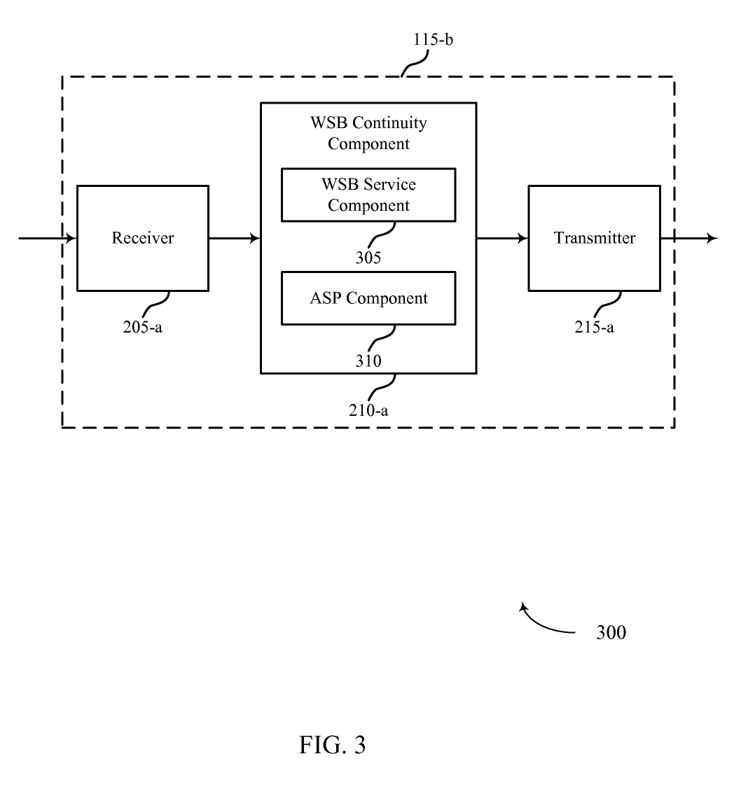

FIG. 3 shows a block diagram 300 of an apparatus 115-b that can be used in a wireless station for wireless communication, in accordance with various examples. The apparatus 115-b may be an example of the aspects of a wireless station 115 described with reference to FIG. 1. It may also be an example of an apparatus 115-a described with reference to FIG. 2. The apparatus 115-b may include a receiver 205-a, a WSB continuity component 210-a, and/or a transmitter 215-a, which may be examples of the corresponding components of apparatus 115-a. The apparatus 115-b may also include a processor (not shown). Each of these components may be in communication with each other. The WSB continuity component 210-a may include a WSB service component 305 and an ASP component 310. The receiver 205-a and the transmitter 215-a may perform the functions of the receiver 205 and the transmitter 215 of FIG. 2, respectively.

The WSB service component 305 may monitor, manage, or otherwise perform functions related to wireless serial bus services for the apparatus 115-b. In some aspects, the WSB service component 305 may perform discovery or enumeration procedures with a device to exchange information necessary to provide serial bus interoperability. The information exchanged during the learning process may include operational configuration information for the device that permits the apparatus 115-b to access various functions of the device, e.g., printing, display, storage, input, etc. Once the discovery process is complete, the apparatus 115-b and the device may be in a WSB service session. The WSB service component 305 may manage continuity of the WSB service by determining or identifying an identifier that can be unique to the WSB service and the device. The WSB service component 305 may communicate the unique identifier (or information indicative thereof) to the device and each may store the unique identifier. The WSB service component 305 may associate other information of the device with the unique identifier, e.g., the device ID.

In some aspects, the WSB service component 305 may provide for continuity of the WSB service based on the unique identifier. For example, if the WSB service session is interrupted or otherwise terminated, the WSB service component 305 may use the unique identifier to avoid performing the learning process again when the apparatus 115-b and the device connect again. For example, the WSB service component 305 may receive information indicating that the device is again connected and available for WSB service and therefore send the unique identifier to the device. The device may acknowledge that it has also stored the unique identifier and therefore supports a second WSB service session without performing the discovery process. Accordingly, the apparatus 115-b and the device may continue the WSB service during a second or subsequent WSB service session more quickly and without performing the enumeration steps again.

The ASP component 310 may monitor, manage, or otherwise perform functions related to providing a wireless communication link for the apparatus 115-b. In some aspects, the ASP component 310 may provide a wireless connection that, from the perspective of the WSB service component 305, emulates a physical connection between the apparatus 115-b and the device. Accordingly, the ASP component 310 may exchange message(s), via the receiver 205-a and/or the transmitter 215-a, with a corresponding ASP component of the device to create the ASP session. The wireless link over which the ASP session communicates may be a Wi-Fi link, e.g., the direct wireless link 125 of FIG. 1. The ASP component 310 may output at least one signal to the WSB service component 305 (or other components) of the apparatus 115-b indicative of the ASP session status, e g., link status indicators.

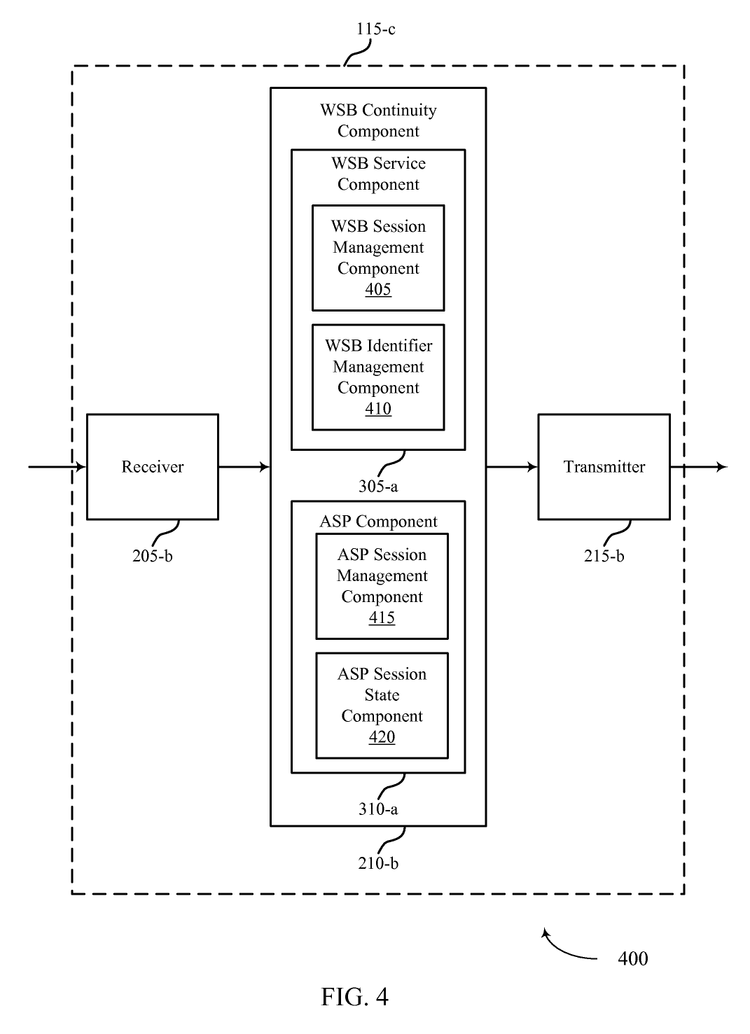

FIG. 4 shows a block diagram 400 of an apparatus 115-c that can be used in a wireless station for wireless communication, in accordance with various examples. The apparatus 115-c may be an example of the aspects of a wireless station 115 described with reference to FIG. 1. It may also be an example of an apparatus 115-a or 115-b described with reference to FIG. 2 or 3, respectively. The apparatus 115-c may include a receiver 205-b, a WSB continuity component 210-b, and/or a transmitter 215-b, which may be examples of the corresponding components of apparatuses 115-a or 115-b. The apparatus 115-c may also include a processor (not shown). Each of these components may be in communication with each other. The WSB continuity component 210-b may include a WSB service component 305-a and an ASP component 310-a. The receiver 205-b and the transmitter 215-b may perform the functions of the receiver 205 and the transmitter 215 of FIG. 2, respectively.

The WSB service component 305-a may be an example of the WSB service component 305 described with reference to FIG. 3 and may include a WSB session management component 405 and a WSB identifier management component 410. The WSB service component 305-a may monitor, manage, or otherwise perform functions related to wireless serial bus services for the apparatus 115-c.

The WSB session management component 405 may manage aspects of a WSB service for the apparatus 115-c. In some aspects, the WSB session management component 405 may perform the discovery process with a device to establish a first WSB service session with the device. The discovery process may be a USB enumeration process, for example. The discovery process and WSB service session may be a first WSB service and corresponding session between the apparatus 115-c and the device. As discussed in greater detail below, the WSB session management component 405 may manage aspects of a second WSB service session where the WSB service persists or continues from the first WSB service session.

The WSB identifier management component 410 may manage aspects of an identifier that can be unique to each WSB service the apparatus 115-c participates in. For example and for a WSB service with a device during an initial WSB service session, the WSB identifier management component 410 may determine a unique identifier for the WSB service provided at least in part via the first WSB service session. The WSB identifier management component 410 may, via the transmitter 215-b, communicate information indicative of the unique identifier to the device. In some aspects, the WSB identifier management component 410 may also manage aspects of storing the unique identifier and sending information or an indicator to the device wherein the device also stores the unique identifier.

In some aspects, the apparatus 115-c may participate in WSB service sessions with more than one device and the WSB identifier management component 410 may determine an identifier that can be unique to each WSB service established during a corresponding WSB service session.

In some aspects, the WSB identifier management component 410 may store the unique identifier based on the WSB service session being closed or terminated. For example, the WSB identifier management component 410 may receive a signal indicating that the WSB service session is being terminated and store the unique identifier based at least in part on the received signal. In another example, the WSB identifier management component 410 may receive information or otherwise determine that the WSB service session has terminated based on a period of inactivity having a predetermined length and storing the unique identifier.

The ASP component 310-a may be an example of the ASP component 310 described with reference to FIG. 3 and may include an ASP session management component 415 and an ASP session state component 420. The ASP component 310-a may monitor, manage, or otherwise perform functions related to providing a wireless communication link for the apparatus 115-c.

The ASP session management component 415 may provide for a wireless link upon which the WSB service session can be established. The wireless link may be ASP session between the ASP session management component 415 and a corresponding ASP session management component of the device. The WSB service session may generally utilize the ASP session for communications and, accordingly, be terminated if and when the underlying ASP session terminates. The ASP session management component 415 may exchange messages with the corresponding ASP session management component of the device to initiate the ASP session, e.g., device ID information, wireless configuration and protocols, etc. Accordingly, the wireless ASP session may emulate a physical connection between the apparatus 115-c and the device.

The ASP session state component 420 may monitor the ASP session and output information indicative of the ASP session state. For example, the ASP session state component 420 may receive a signal that the ASP session is to be terminated (e.g., from a user closing an application on the apparatus 115-c) and output information indicating that the ASP session is closed. As another example, the ASP session state component 420 may snoop or listen for messages being exchanged via the ASP session and if there is no activity for a predetermined time period, determine that the ASP session has terminated. The ASP session state component 420 may again output information indicating that the ASP session is terminated. For example, the ASP session state component 420 may output information indicative of the state of the ASP session to the WSB service component 305-a.

In some aspects, the WSB session management component 405 may determine that the WSB service session has terminated based on receipt of the indication from the ASP session state component 420. The WSB session management component 405 may determine that the device is available for a second WSB service session. For example, the ASP component 310-a may establish a second ASP session with the device and receive device ID information during establishment of the second ASP session. The WSB session management component 405 may establish a second WSB service session based at least in part on the unique identifier. For example, the WSB identifier management component 410 may output information indicative of the unique identifier for the initial WSB service performed during the initial WSB service session with the device. The information may be communicated to the device during a remote wakeup procedure, for example, where a remote wakeup response from the device confirming the unique identifier indicates that it supports WSB service continuity with the apparatus 115-c using the unique identifier. Accordingly, the WSB session management component 405 may refrain from performing a second discovery process to establish the second WSB service session.

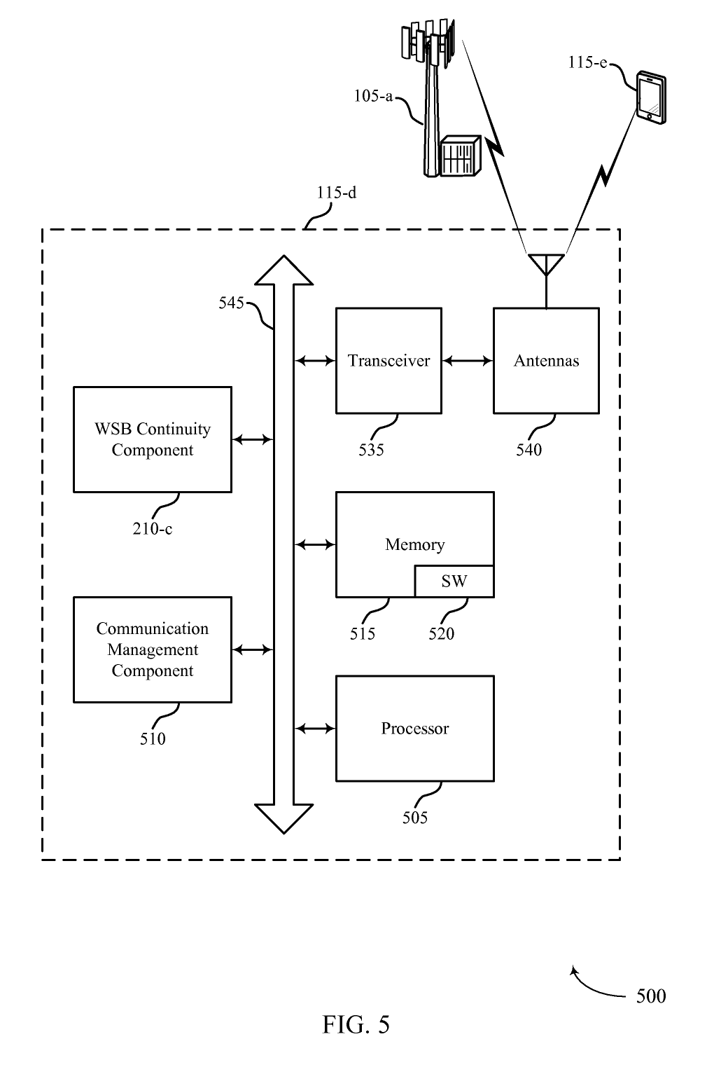

Turning to FIG. 5, a diagram 500 is shown that illustrates a wireless station 115-d for persistent WSB session functions across more than one WSB service session using a unique identifier for the WSB service. The wireless station 115-d may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless station 115-d may have an internal power supply (not shown), such as a small battery, to facilitate mobile operation. The wireless station 115-d may be an example of the wireless stations and/or apparatuses 115 of FIGS. 1-4.

The wireless station 115-d may include a processor 505, a memory 515, a transceiver 535, antennas 540, a WSB continuity component 210-c, and a communication management component 510. The WSB continuity component 210-c may be an example of the WSB continuity component 210 of FIGS. 2-4. Each of these components may be in communication with each other, directly or indirectly, over at least one bus 545.

The memory 515 may include RAM and ROM. The memory 515 may store computer-readable, computer-executable software (SW) code 520 containing instructions that, when executed, cause the processor 505 to perform various functions described herein for WSB service continuity. Alternatively, the software code 520 may not be directly executable by the processor 505 but cause the computer (e.g., when compiled and executed) to perform functions described herein.

The processor 505 may include an intelligent hardware device, e.g., a CPU, a microcontroller, an ASIC, etc. The processor 505 may process information received through the transceiver 535 and/or to be sent to the transceiver 535 for transmission through the antennas 540. The processor 505 may handle, alone or in connection with the WSB continuity component 210-c, various aspects for WSB service continuity during more than on WSB service session based on an identifier that can be unique to the WSB service.

The transceiver 535 may communicate bi-directionally with APs 105 in FIG. 1 and/or with other wireless stations, mobile devices, and/or apparatuses 115 of FIGS. 1-4. The transceiver 535 may be implemented as at least one transmitter component and at least one separate receiver component. The transceiver 535 may include a modem to modulate the packets and provide the modulated packets to the antennas 540 for transmission, and to demodulate packets received from the antennas 540. While the wireless station 115-d may include a single antenna, there may be aspects in which the wireless station 115-d may include multiple antennas 540.

According to the architecture of FIG. 5, the wireless station 115-d may further include a communication management component 510. The communication management component 510 may manage communications with various access points 105-a, wireless stations 115-e, etc. The communication management component 510 may be a component of the wireless station 115-d in communication with some or all of the other components of the wireless station 115-d over the at least one bus 545. Alternatively, functionality of the communication management component 510 may be implemented as a component of the transceiver 535, as a computer program product, and/or as at least one controller element of the processor 505.

The components of the wireless station 115-d may implement aspects discussed above with respect to FIGS. 1-4, and those aspects may not be repeated here for the sake of brevity.

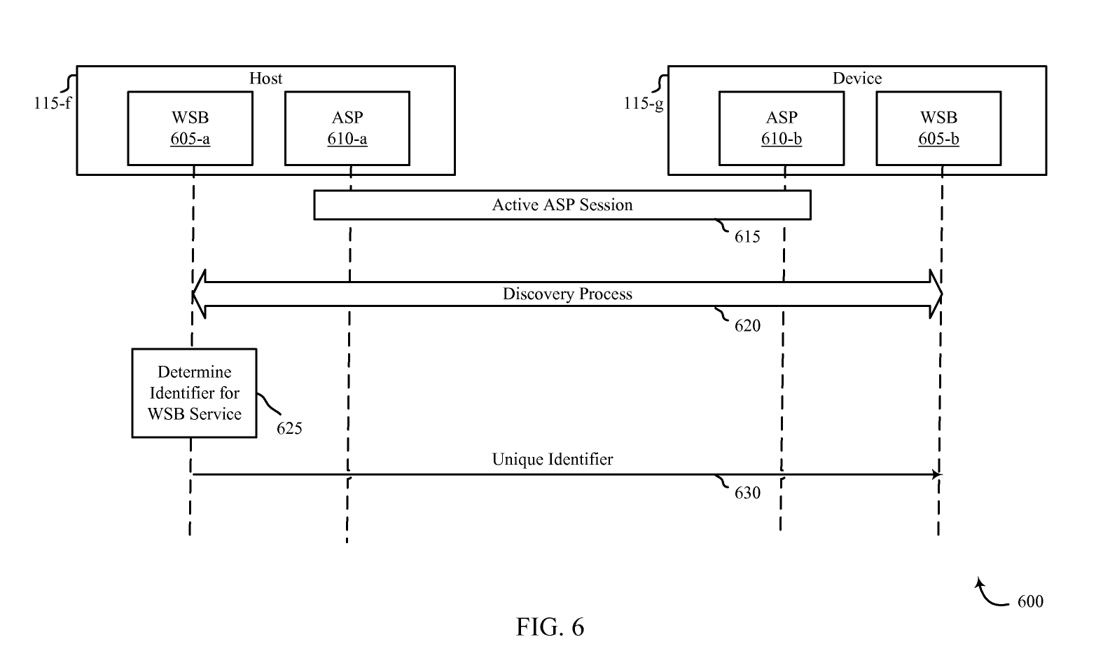

FIG. 6 is a swim lane diagram 600 illustrating aspects of wireless communication, in accordance with various aspects of the present disclosure. The diagram 600 may illustrate aspects of the WLAN network 100 described with reference to FIG. 1. The diagram 600 includes a host 115-f and a device 115-g. The host 115-f and the device 115-g may be examples of at least one of the wireless stations, or the apparatuses 115, or a combination thereof described above with respect to FIGS. 1-5. Each of the host 115-f and the device 115-g may include a WSB component 605 and an ASP component 610. The WSB component 605 may be an example of the WSB service component 305 described with reference to FIGS. 3 and 4. The ASP component 610 may be an example of the ASP component 310 described with reference to FIGS. 3 and 4. The WSB component 605 and/or the ASP component 610 may be a protocol or function operating on the host 115-f and/or the device 115-g. Generally, the diagram 600 illustrates aspects of WSB service continuity based on an identifier shared and stored by the host 115-f and the device 115-g. In some examples, a system device, such as one of the wireless stations and/or apparatuses 115 may execute sets of codes to control the functional elements of the host to perform some or all of the functions described below.

At block 615, the host 115-f and the device 115-g have an active ASP session. For example, the ASP components 610 have negotiated an ASP session and exchanged message(s) to form the ASP session. Generally, the ASP session may provide for a wireless connection between the host 115-f and the device 115-g that emulates a physical connection. At 620, the WSB component 605-a of the host 115-f and the WSB component 605-b of the device 115-g may perform a discovery process. For example, discovery process may be a USB enumeration process where the host 115-f receives information from the device 115-g associated with operational requirements for the device 115-g, e.g., driver information, capability information, device ID, etc. The discovery process may form, or be a component of, establishing a WSB service session whereby WSB services are implemented between the host 115-f and the device 115-g.

At 625, the WSB component 605-a of the host 115-f may determine or otherwise identify an identifier that can be unique to the WSB service. The identifier may be a unique series of numbers, alpha-numeric characters, etc., that can be used to identify the WSB service between the host 115-f and the device 115-g. At 630, the WSB component 605-a of the host 115-f may communicate the unique identifier, or information indicative of such identifier, to the WSB component 605-b of the device 115-g. The host 115-f and/or the device 115-g may store the unique identifier and use it to continue the WSB service in a subsequent WSB service session. The continued WSB service may permit establishing the subsequent WSB service session without having to perform another discovery process, such as was performed at 620.

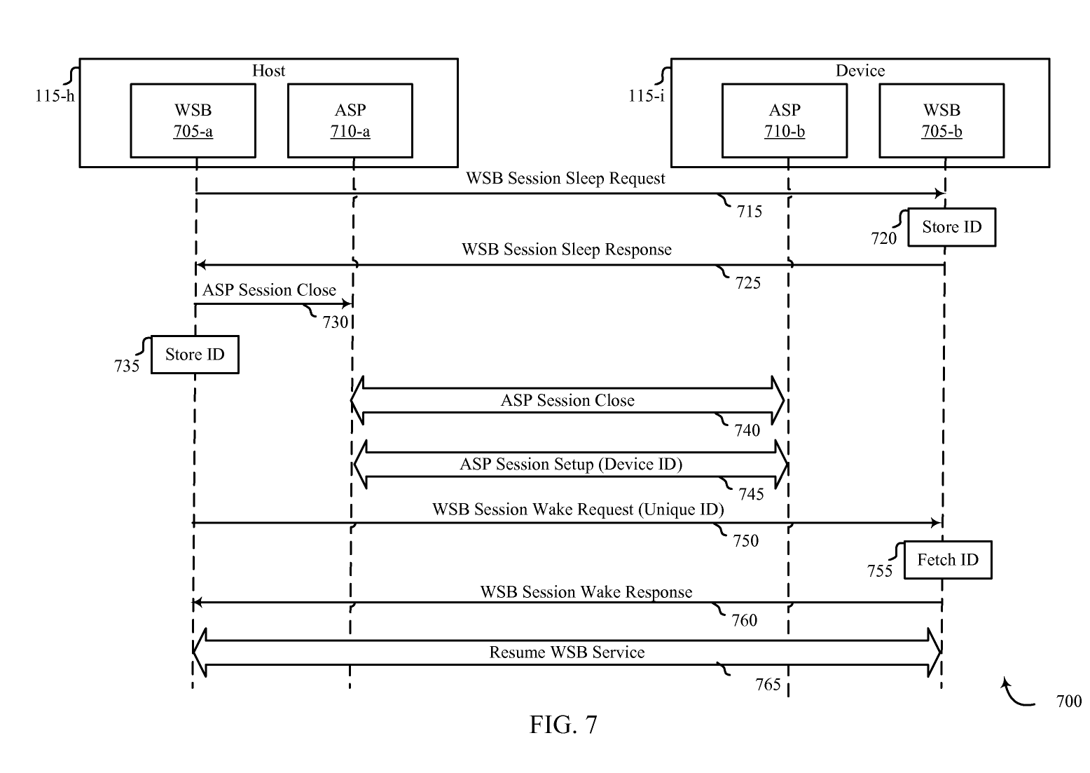

FIG. 7 is a swim lane diagram 700 illustrating aspects of wireless communication, in accordance with various aspects of the present disclosure. The diagram 700 may illustrate aspects of the WLAN network 100 described with reference to FIG. 1. The diagram 700 includes a host 115-h and a device 115-i. The host 115-h and the device 115-i may be examples of at least one of the wireless stations, or the apparatuses 115, or a combination thereof described above with respect to FIGS. 1-5. Each of the host 115-h and the device 115-i may include a WSB component 705 and an ASP component 710. The WSB component 705 may be an example of the WSB service component 305 described with reference to FIGS. 3 and 4. The ASP component 710 may be an example of the ASP component 310 described with reference to FIGS. 3 and 4. The WSB component 705 and/or the ASP component 710 may be a protocol or function operating on the host 115-h and/or the device 115-i. Generally, the diagram 700 illustrates aspects of WSB service continuity based on an identifier shared and stored by the host 115-h and the device 115-i. In some examples, a system device, such as one of the wireless stations and/or apparatuses 115 may execute sets of codes to control the functional elements of the host to perform some or all of the functions described below. According to the architecture of diagram 700, the host 115-h and the device 115-i are in an active WSB service session via an active ASP session and have exchanged the unique identifier associated with the WSB session.

At 715, the WSB component 705-a may send a sleep request message to the WSB component 705-b to signal affirmative termination of the WSB service session. In response and at 720, the WSB component 705-b may store the unique identifier associated with the WSB service. The WSB component 705-b may respond at 725 by sending a sleep response message to the WSB component 705-a. The sleep response message may include information indicating that the unique identifier for the WSB service has been stored at the device 115-i. At 730, the WSB component 705-a may send a message to the ASP component 710-a indicating that the WSB service session is terminated and, therefore, requesting that the ASP session terminate. At 735, the WSB component 705-a may store the unique identifier for the WSB service. In some aspects, the WSB component 705-a may store additional information associated with the device 115-i along with the unique identifier, e.g., device ID, device configuration and functions supported, etc.

At 740, the ASP component 710-a may exchange at least one message with the ASP component 710-b to close the ASP session. Accordingly, the WSB service session may have terminated and the host 115-h and the device 115-i may not have an active WSB service session and/or ASP session. At 745, the host 115-h and the device 115-i may initiate a second ASP session setup procedure. For example, the host 115-h and the device 115-i may have come into wireless communication range again and, based on sensing the wireless communication capability, exchanged messages to establish the second ASP session. In some aspects, the ASP session setup messages may include the device 115-i sending information indicative of its ID to the host 115-h. For example, the device 115-i may utilize a media access control (MAC) identification for the wireless communication link and this may be exchanged during the ASP session setup messages. Other device ID information may include an electronic serial number of the device 115-i, or some other ID information that can be unique to and identifies the device 115-i.

At 750, the WSB component 705-a may send a WSB session wake request to the WSB component 705-b. The wake request message may include the unique identifier for the WSB service established during a first or previous WSB service session between the host 115-h and the device 115-i. In some aspects, the WSB component 705-a may receive the device ID of the device 115-i during the ASP session setup procedure and identify the unique identifier for the WSB service based on the device ID. At 755, the WSB component 705-b may fetch the unique identifier for the WSB service based on the unique identifier received in the wake request message. For example, the WSB component 705-b may access a storage location to determine if it has previously stored a unique identifier corresponding to the unique identifier received in the wake request message. At 760, the WSB component 705-b may send a WSB session wake response message to the WSB component 705-a that includes an indication confirming that it has stored the unique identifier for the WSB service. Accordingly and at 765, the WSB components 705 may resume or otherwise continue the WSB service based on the unique identifier. The WSB service may be resumed without performing a discovery procedure to enumerate the aspects of the device 115-i.

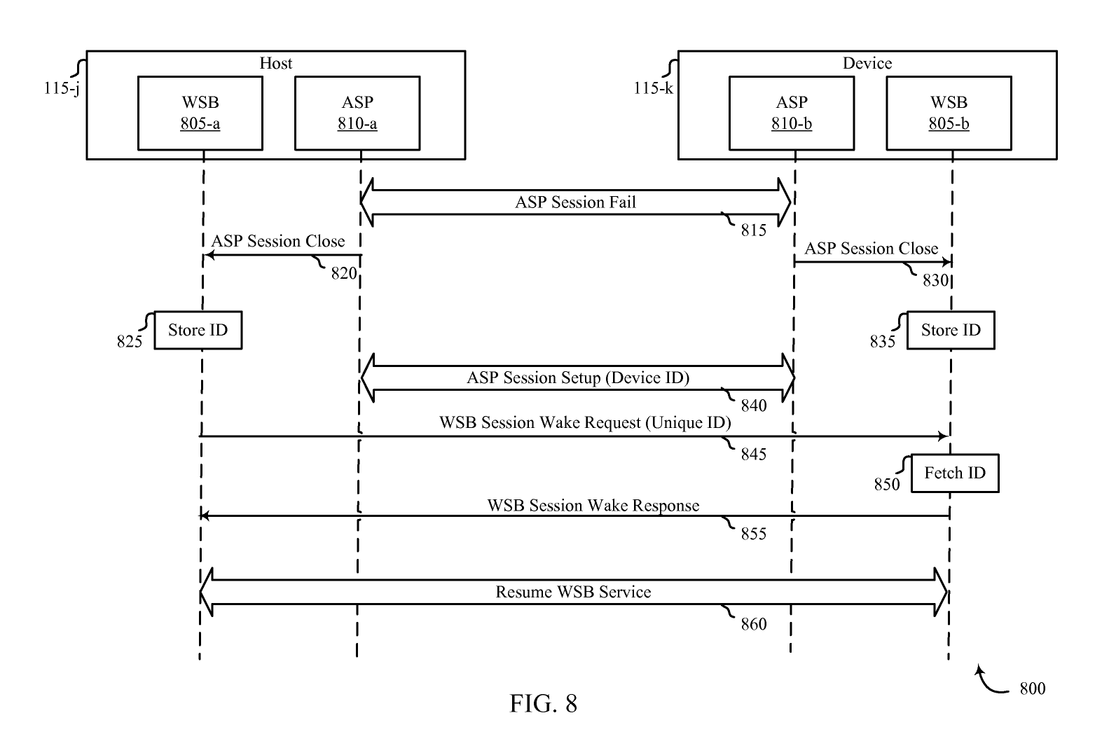

FIG. 8 is a swim lane diagram 800 illustrating aspects of wireless communication, in accordance with various aspects of the present disclosure. The diagram 800 may illustrate aspects of the WLAN network 100 described with reference to FIG. 1. The diagram 800 includes a host 115-j and a device 115-k. The host 115-j and the device 115-k may be examples of at least one of the wireless stations, or the apparatuses 115, or a combination thereof described above with respect to FIGS. 1-5. Each of the host 115-j and the device 115-kmay include a WSB component 805 and an ASP component 810. The WSB component 805 may be an example of the WSB service component 305 described with reference to FIGS. 3 and 4. The ASP component 810 may be an example of the ASP component 310 described with reference to FIGS. 3 and 4. The WSB component 805 and/or the ASP component 810 may be a protocol or function operating on the host 115-j and/or the device 115-k. Generally, the diagram 800 illustrates aspects of WSB service continuity. In some examples, a system device, such as one of the wireless stations and/or apparatuses 115 may execute sets of codes to control the functional elements of the host to perform some or all of the functions described below. According to the architecture of diagram 800, the host 115-j and the device 115-k are in an active WSB service session via an active ASP session and have exchanged the unique identifier associated with the WSB session.

At 815, the ASP components 810 may determine that the ASP session has failed. For example, the ASP components 810 may determine that the ASP session has been inactive for a predetermined time period. In other examples, the ASP components 810 may determine that the ASP session has otherwise timed out and therefore closed. In response and at 820, the ASP component 810-a may send a signal to the WSB component 705-a indicating that the ASP session has terminated. At 825, the WSB component 805-a may store the unique identifier associated with the WSB service. Similarly and at 830, the ASP component 810-b may send a signal to the WSB component 805-b indicating that the ASP session has terminated. At 835, the WSB component 805-b may store the unique identifier associated with the WSB service.

At 840, the host 115-j and the device 115-k may initiate a second ASP session setup procedure. For example, the host 115-j and the device 115-k may have come into wireless communication range again and, based on sensing the wireless communication capability, exchanged at least one message to establish the second ASP session. In some aspects, the ASP session setup messages may include the device 115-k sending information indicative of its ID to the host 115-j.

At 845, the WSB component 805-a may send a WSB session wake request to the WSB component 805-b. The wake request message may include the unique identifier for the WSB service established during a first or previous WSB service session between the host 115-j and the device 115-k. At 850, the WSB component 805-b may fetch the unique identifier for the WSB service based on the unique identifier received in the wake request message. At 855, the WSB component 805-b may send a WSB session wake response message to the WSB component 805-a that includes an indication confirming that it has stored the unique identifier for the WSB service. Accordingly and at 860, the WSB components 805 may resume or otherwise continue the WSB service based on the unique identifier. The WSB service may be resumed without performing a discovery procedure to enumerate the aspects of the device 115-k.

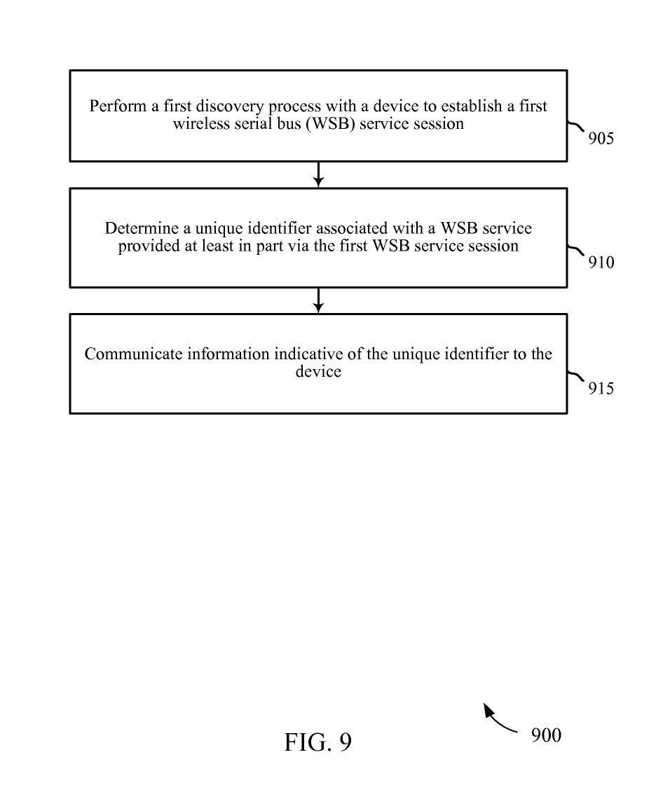

FIG. 9 is a flow chart illustrating an example of a method 900 for wireless communication, in accordance with various aspects of the present disclosure. For clarity, the method 900 is described below with reference to aspects of the wireless stations described with reference to FIG. 1, the apparatuses described with reference to FIGS. 2-5, and/or the hosts described with reference to FIGS. 6-8. In some examples, a wireless station may execute sets of codes to control the functional elements of the wireless station to perform the functions described below. Additionally or alternatively, the wireless station may perform the functions described below using special-purpose hardware.

At block 905, the method 900 may include performing a first discovery process with a device to establish a first WSB service session. The discovery process may include a USB enumeration procedure where the host learns the operational capabilities and configuration of the device. In some aspects, the WSB service session may be established atop an underlying ASP session between the host and the device. At block 910, the method 900 may include determining a unique identifier associated with a WSB service provided at least in part via the first WSB service session. In some aspects, the WSB service may be a USB over Wi-Fi service. At block 915, the method 900 may include communicating information indicative of the unique identifier to the device. In some aspects, the host and the device may store the unique identifier and may associate the unique identifier with device ID information associated with the device.

The operation(s) at blocks 905, 910, and 915 may be performed using the WSB continuity component 210 described with reference to FIGS. 2-5.

Thus, the method 900 may provide for wireless communication. It should be noted that the method 900 can be just one implementation and that the operations of the method 900 may be rearranged or otherwise modified such that other implementations are possible.

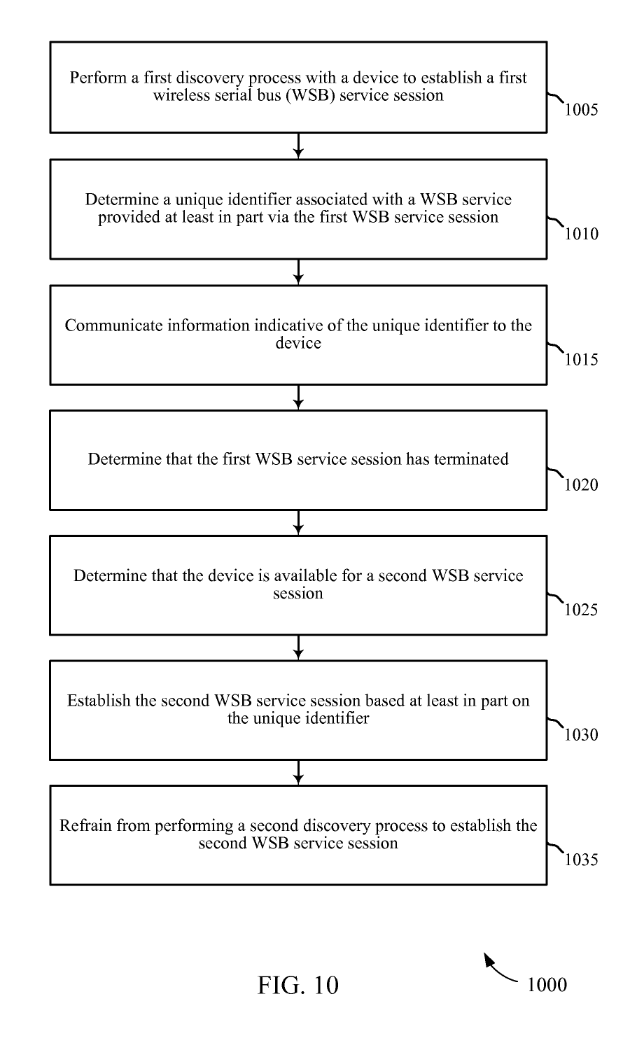

FIG. 10 is a flow chart illustrating an example of a method 1000 for wireless communication, in accordance with various aspects of the present disclosure. For clarity, the method 1000 is described below with reference to aspects of the wireless stations described with reference to FIG. 1, the apparatuses described with reference to FIGS. 2-5, and/or the hosts described with reference to FIGS. 6-8. In some examples, a wireless station may execute sets of codes to control the functional elements of the wireless station to perform the functions described below. Additionally or alternatively, the wireless station may perform the functions described below using special-purpose hardware.

At block 1005, the method 1000 may include performing a first discovery process with a device to establish a first WSB service session. The discovery process may include a USB enumeration procedure where the host learns the operational capabilities and configuration of the device. The WSB service session may be established atop an underlying ASP session between the host and the device. At block 1010, the method 1000 may include determining a unique identifier associated with a WSB service provided at least in part via the first WSB service session. In some aspects, the WSB service may be a USB over Wi-Fi service. At block 1015, the method 1000 may include communicating information indicative of the unique identifier to the device. In some aspects, the host and the device may store the unique identifier and may associate the unique identifier with device ID information associated with the device.

At block 1020, the method 1000 may include determining that the first WSB service session has terminated. The WSB service session may terminate intentionally or due to a communication failure. In some examples, the underlying ASP session may fail, thereby terminating the WSB service session. At block 1025, the method 1000 may include determining that the device is available for a second WSB service session. In some aspects, the device may be available based on a second ASP session being setup once the host and the device are within wireless communication range again.

At block 1030, the method 1000 may include establishing a second WSB service session based at least in part on the unique identifier. For example, the host may send the unique identifier to the device and, if the device confirms that it has stored the unique identifier, the second WSB service session can be established. At block 1035, the method 1000 may include refraining from performing a second discovery process to establish the second WSB service session. For example, the host and the device may establish the second WSB service session using stored information associated with the unique identifier rather than performing a USB enumeration process.

The operation(s) at blocks 1005, 1010, 1015, 1020, 1025, 1030, and 1035 may be performed using the WSB continuity component 210 described with reference to FIGS. 2-5.

Thus, the method 1000 may provide for wireless communication. It should be noted that the method 1000 is just one implementation and that the operations of the method 1000 may be rearranged or otherwise modified such that other implementations are possible.

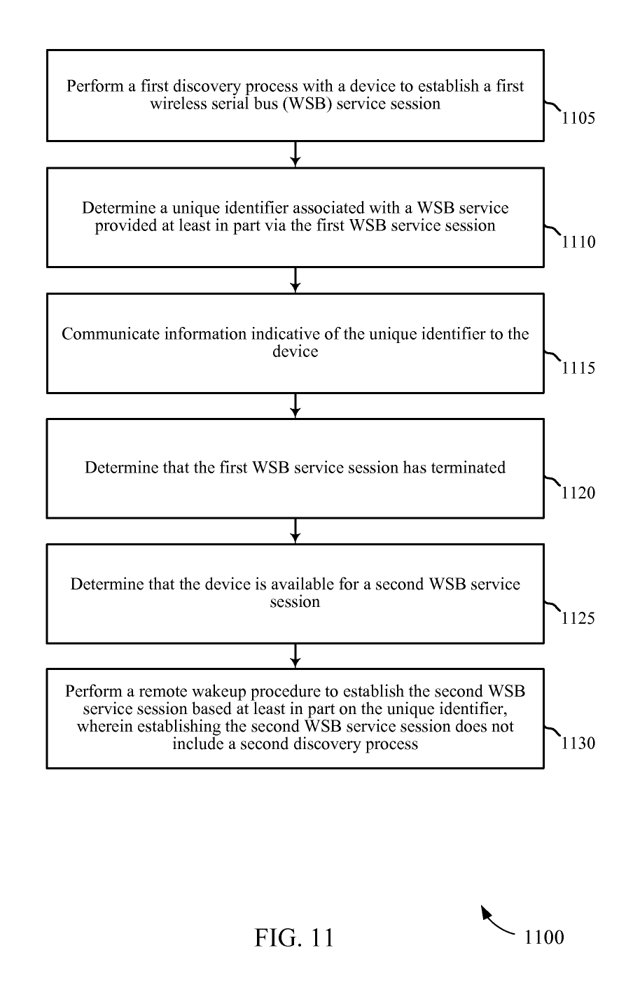

FIG. 11 is a flow chart illustrating an example of a method 1100 for wireless communication, in accordance with various aspects of the present disclosure. For clarity, the method 1100 is described below with reference to aspects of the wireless stations described with reference to FIG. 1, the apparatuses described with reference to FIGS. 2-5, and/or the hosts described with reference to FIGS. 6-8. In some examples, a wireless station may execute sets of codes to control the functional elements of the wireless station to perform the functions described below. Additionally or alternatively, the wireless station may perform the functions described below using special-purpose hardware.

At block 1105, the method 1100 may include performing a first discovery process with a device to establish a first WSB service session. The discovery process may include a USB enumeration procedure where the host learns the operational capabilities and configuration of the device. The WSB service session may be established atop an underlying ASP session between the host and the device. At block 1110, the method 1100 may include determining a unique identifier associated with a WSB service provided at least in part via the first WSB service session. At block 1115, the method 1100 may include communicating information indicative of the unique identifier to the device. In some aspects, the host and the device may store the unique identifier and may associate the unique identifier with device ID information associated with the device.

At block 1120, the method 1100 may include determining that the first WSB service session has terminated. The WSB service session may terminate intentionally or due to a communication failure. In some examples, the underlying ASP session may fail, thereby terminating the WSB service session. At block 1125, the method 1100 may include determining that the device is available for a second WSB service session. In some aspects, the device may be available based on a second ASP session being setup once the host and the device are within wireless communication range again.

At block 1130, the method 1100 may include performing a remote wakeup procedure to establish a second WSB service session based at least in part on the unique identifier. Establishing the second WSB service session may not include performing a second discovery process. For example, the host and the device may establish the second WSB service session using stored information associated with the unique identifier rather than performing the second discovery process.

The operation(s) at blocks 1105, 1110, 1115, 1120, 1125, and 1130 may be performed using the WSB continuity component 210 described with reference to FIGS. 2-5.

Thus, the method 1100 may provide for wireless communication. It should be noted that the method 1100 is just one implementation and that the operations of the method 1100 may be rearranged or otherwise modified such that other implementations are possible.

In some examples, aspects from two or more of the methods 900, 1000, and/or 1100 may be combined. It should be noted that the methods 900, 1000, etc. are just example implementations, and that the operations of the methods 900-1100 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted over as at least one instruction or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection can be properly termed a computer-readable medium. For example, if the software can be transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
performing a first discovery process with a device to establish a first wireless serial bus (WSB) service session;
determining a unique identifier associated with a WSB service provided at least in part via the first WSB service session; and
communicating information indicative of the unique identifier to the device.

2. The method of claim 1, further comprising:
determining that the first WSB service session has terminated;
determining that the device is available for a second WSB service session; and
establishing the second WSB service session based at least in part on the unique identifier.

3. The method of claim 2, further comprising:
refraining from performing a second discovery process to establish the second WSB service session.

4. The method of claim 2, further comprising:
communicating information indicative of the unique identifier to the device to establish the second WSB service session.

5. The method of claim 2, wherein determining that the device is available for a second WSB service session comprises:
receiving information indicative of a device identification (ID) for the device; and
associating the device ID with the unique identifier for the first WSB service session.

6. The method of claim 2, wherein establishing the second WSB service session comprises:
communicating information associated with a remote wakeup procedure.

7. The method of claim 1, further comprising:
storing the unique identifier.

8. The method of claim 7, further comprising:
storing a plurality of unique identifiers for a corresponding plurality of devices, each of the plurality of devices having previously established a WSB service session.

9. The method of claim 1, further comprising:
communicating an indicator to the device associated with the device storing the unique identifier.

10. The method of claim 1, further comprising:
receiving a signal indicating that the first WSB service session is being terminated; and
storing the unique identifier based at least in part on the receiving.

11. The method of claim 1, further comprising:
determining that the first WSB service session has terminated based on a period of inactivity having a predetermined length; and
storing the unique identifier based at least in part on the determining.

12. The method of claim 1, wherein the first WSB service session is established via an application service platform (ASP) session.

13. The method of claim 1, wherein the WSB service is associated with a universal serial bus (USB) over Wi-Fi service.

14. The method of claim 13, wherein the first discovery process comprises a USB enumeration process.

15. An apparatus for wireless communication, comprising:
a processor;
memory in electronic communication with the processor; and
instructions being stored in the memory, the instructions being executable by the processor to:
perform a first discovery process with a device to establish a first wireless serial bus (WSB) service session;
determine a unique identifier associated with a WSB service provided at least in part via the first WSB service session; and
communicate information indicative of the unique identifier to the device.

16. The apparatus of claim 15, further comprising instructions executable by the processor to:
determine that the first WSB service session has terminated;
determine that the device is available for a second WSB service session; and
establish the second WSB service session based at least in part on the unique identifier.

17. The apparatus of claim 16, further comprising instructions executable by the processor to:
refrain from performing a second discovery process to establish the second WSB service session.

18. The apparatus of claim 16, further comprising instructions executable by the processor to:
communicate information indicative of the unique identifier to the device to establish the second WSB service session.

19. The apparatus of claim 16, wherein the instructions to determine that the device is available for a second WSB service session are further executable by the processor to:
receive information indicative of a device identification (ID) for the device; and
associate the device ID with the unique identifier for the first WSB service session.

20. An apparatus for wireless communication, comprising:
means for performing a first discovery process with a device to establish a first wireless serial bus (WSB) service session;
means for determining a unique identifier associated with a WSB service provided at least in part via the first WSB service session; and
means for communicating information indicative of the unique identifier to the device.
